(19) United States
(12) Patent Application Publication
(10) Pub. No.: US 2007/0226456 A1
(43) Pub. Date: Sep. 27, 2007

(54) System and method for employing multiple processors in a computer system

(76) Inventors: Mark Shaw, Richardson, TX (US); Stuart Allen Berke, Austin, TX (US); Denis Foley, Shrewsbury, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/386,026

(22) Filed: Mar. 21, 2006

(51) Int. Cl. G06F 15/00

(52) U.S. Cl. 712/10

(57) ABSTRACT

There is provided a system and a method for employing multiple processors in a computer system. More specifically, there is provided a computer system comprising a first cell board including a first central processing unit, a second central processing unit, and a first data agent coupled to the first and second central processing units and configured to transmit signals from the first and second central processing units to a first crossbar circuit. There is also provided a second cell board including a third central processing unit coupled to the first central processing unit via a point-to-point data link, a fourth central processing unit, and a second data agent coupled to the third and fourth central processing units and configured to transmit signals from the third and fourth central processing units to a second crossbar circuit.

### BACKGROUND

This section is intended to introduce the reader to various aspects of art, which may be related to various aspects of the present invention that are described and claimed below. This discussion is believed to be helpful in providing the reader with background information to facilitate a better understanding of the various aspects of the present invention. Accordingly, it should be understood that these statements are to be read in this light, and not as admissions of prior art.

Symmetric multiprocessing (“SMP”) is the processing of computer instructions and/or programs by multiple processors under the control of a single operating system (“OS”) using a common memory and/or input/output (“I/O”) devices. By leveraging the processing power of multiple independent processors, such as sixty four processors for example, SMP systems may be able to generate significant computing power. As such, SMP systems can provide a more economical alternative to super computers or mainframes that typically rely on a small number of more expensive, custom-designed processors.

SMP systems employ multiple interconnected processors that cooperate and communicate with each other. There are a variety of factors, however, that can affect how efficiently the processors within an SMP system can communicate with each other, and, thus, how efficiently the SMP system can operate. One factor that affects the communication between the processors in an SMP system is the available data rate of the connections between the processors, which is referred to as the bandwidth. Higher bandwidth connections between processors enable more data to be communicated between two processors in a given period of time as compared to lower bandwidth connections. As such, higher bandwidth connections facilitate more efficient (i.e., faster) SMP systems. Similarly, SMP systems may also benefit from shorter transmission times, referred to as latencies, between the processors. For example, two processors may be able to cooperate more efficiently if they are directly coupled to one another versus if they are coupled to one another through a switch or other signal routing system. This is the case because transmitting data through the switch or other signal routing system can introduce transmission delays that are not present when signals are transmitted directly from one processor to another. Lastly, the efficiency of an SMP system may be also be affected by the redundancy of the connections between the processors. Increased redundancy can mitigate the effects of outages, malfunctions, and/or maintenance, and, consequently, can increase the robustness and computing power of an SMP system.

The embodiments described herein may be directed towards increasing bandwidth, decreasing latencies, and/or increasing redundancy in an SMP system.

### BRIEF DESCRIPTION OF THE DRAWINGS

Advantages of the invention may become apparent upon reading the following detailed description and upon reference to the drawings in which:

FIG. 1 is a block diagram of an exemplary cell board pair of a symmetric multiprocessing system in accordance with an exemplary embodiment of the present invention;

FIG. 2 is a block diagram of a symmetric multiprocessing system in accordance with an exemplary embodiment of the present invention;

FIG. 3 is a graphical representation of a physical implementation of the symmetric multiprocessing system of FIG. 2 in accordance with an exemplary embodiment of the present invention; and

FIG. 4 is a block diagram of one alternative embodiment the cell board pair, as illustrated in FIG. 1, in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The embodiments described herein may be directed towards computer topologies and architectures that may be employed with a wide range of currently-available processors to create symmetric multiprocessing (“SMP”) systems that exhibit higher bandwidths, lower latencies, and/or greater redundancies than conventional systems. For example, as will be described in greater detail below, in one embodiment, there is provided an SMP system composed of two groups of thirty-two central processing units (“CPUs”), such that all of the CPUs within a group of CPUs can communicate with each other over no more than a single crossbar switch (referred to as a “crossbar hop”) and all of the CPUs within the SMP system can communicate over no more two crossbar hops.

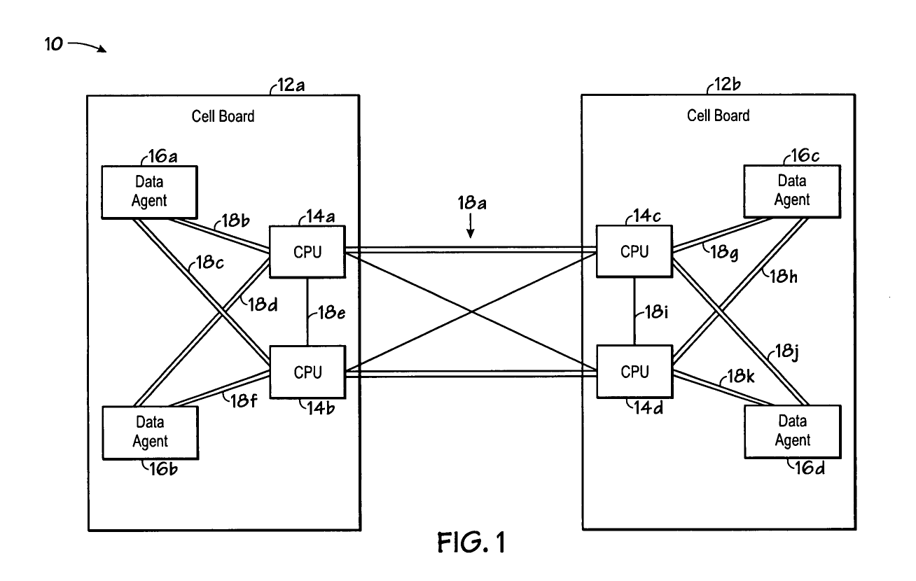

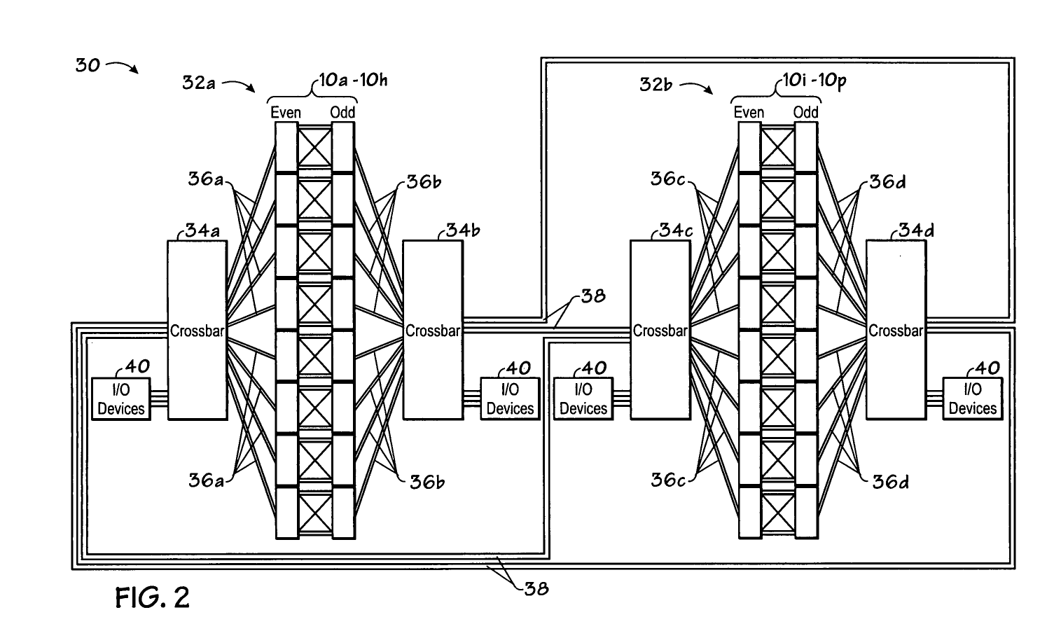

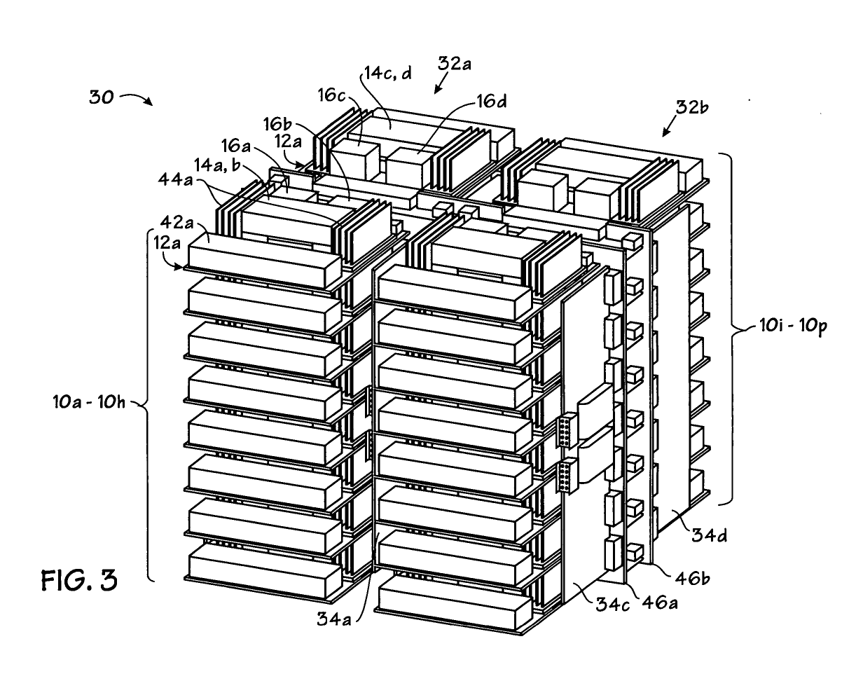

Turning now to the drawings and referring initially to FIG. 1, an exemplary cell board pair from a symmetric multiprocessing system in accordance with one embodiment is illustrated and generally designated by a reference numeral 10. The exemplary cell board pair 10 may include cell boards 12a and 12b. The cell boards 12a and 12b may be any suitable type of printed circuit board or other system suitable for interconnecting computer processors and/or other components as described below. For ease of description in connection with later figures, the cell board 12a will be referred to as the even cell board 12a and the cell board will be referred to as the odd cell board 12b based on the location of the cell boards 12a and 12b within a symmetric multiprocessing system 30 described below in regards to FIGS. 2 and 3.

As illustrated in FIG. 1, the cell boards 12a and 12b may include central processing units (“CPU”) 14a, 14b, 14c, and 14d (hereafter “14a-d”). The CPUs 14a-d may be any type of processor that employs point-to-point differential signaling data links 18a-k for communication. Unlike earlier processors which relied on bus designs, such as a front side bus, to communicate with CPUs, the CPUs 14a-d employ point-to-point differential signaling data links to directly communicate with other CPUs and devices that are also configured to communicate using point-to-point data links. In one embodiment, the CPUs 14a-d may communicate over data links 18a-k that include one or more serializer/deserializer (“SERDES”) differential pairs that are capable of carrying out 2.5 or more gigatransfers (“GT”) per second per pair. For example, the CPUs 14a-d may be configured to communicate over somewhere between approximately twelve SERDES pairs and twenty SERDES pairs for a resulting bandwidth of thirty or more gigabytes (“GB”) per second between CPUs 14a-d. It should be noted, however, that in some embodiments the CPUs 14a-d may also employ a traditional bus in addition to the point-to-point links 18a-k.

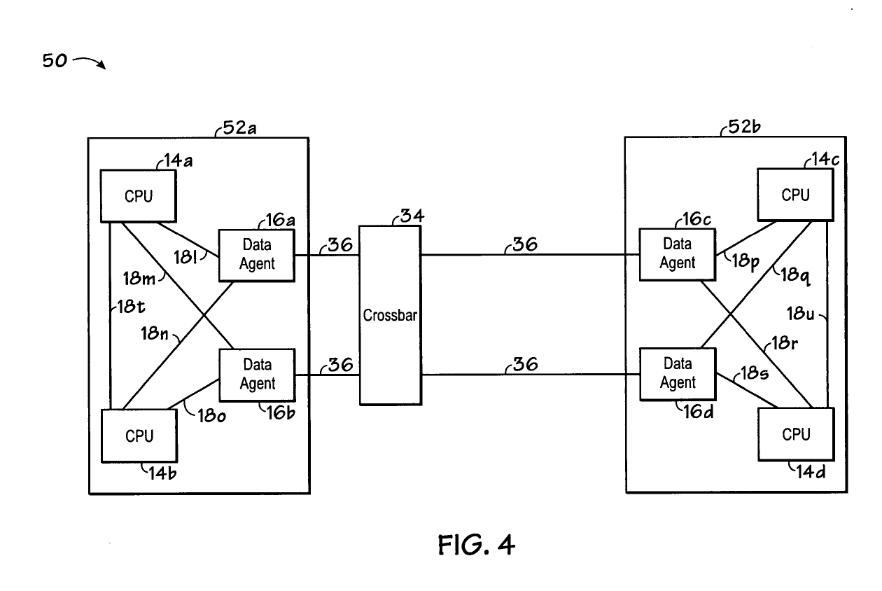

In one embodiment, the CPUs 14a-d may be a processor from the Itanium Processor Family produced by Intel. Other examples of suitable CPUs 14a-d may include the Alpha EV7, produced by Alpha Processors, the Opteron produced by Advanced Micro Devices, and the Power 4/5 produced by International Business Machines. As described above, the CPUs 14a-d may be configured to communicate with one another, with input/output (“I/O”) devices, or with other components via the point-to-point data links 18a-k. In one embodiment, each of the CPUs 14a-d may include anywhere from two to twenty point-to-point data links 18a-k. For example, in the embodiment illustrated in FIG. 1, the CPUs 14a-d may each employ eight data links 18a-k, whereas in the embodiment illustrated in FIG. 4, each of the CPUs 14a-d employ four data links 181-s.

As described above, the CPUs 14a-d may be interconnected with each other via the data links 18a. The data links 18a may be wires, cables, fiber optic lines, or traces that connect to point-to-point data ports on the CPUs 14a-d. In one embodiment, the data links 18a may include pairs of wires configured to transmit SERDES data between SERDES ports on the CPUs 14a-d. In the embodiment illustrated in FIG. 1, each of the CPUs 14a-d may be interconnected with each of the other CPUs 14a-d by at least one data link 18a. For example, the CPU 14a is interconnected with the CPU 14c via two data links 18a, with the CPU 14d via one data link 18a, and with the CPU 14b via one data link 18e. As such, the pair of cell boards 10 provides at least one direct connection between the CPUs 14a and 14b on the even cell board 12a and the CPUs 14c and 14d on the odd cell board 12b. As will be described further below in regard to FIGS. 2 and 3, these direct connections between the cell boards 12a-b and between the CPUs 14a-d may facilitate an SMP system that exhibits higher bandwidth, lower latencies, and/or more redundancies than conventional SMP systems.

The cell boards 12a and 12b may also include data agents 16a, 16b, 16c, and 16d (hereafter “16a-d”). The data agents 16a-d may include one or more integrated circuits (and their related memory and/or storage) that are configured to relay information between the CPUs 14a-d and other CPUs 14a-d, I/O devices, and/or other components of an SMP system. As illustrated, the data agents 16a-d may be coupled to the CPUs 14a-d by data links 18b-k. As with the data links 18a, the data links 18b-k may be wires, cables, fiber optic lines, or traces that couple to the point-to-point data ports on the CPUs 14a-d. In one embodiment, the data links 18a may include pairs of wires configured to transmit SERDES data between SERDES ports on the CPUs 14a-d and SERDES ports on the data agents 16a-d.

As will be described further below, the data agents 16a-d may expand the communication capabilities of the CPUs 14a-d beyond the number of data links 18a-k located on each of the CPUs 14a-d by enabling the CPUs 14a-d to communicate with other components in an SMP system via a switch or other signal routing system. It will be appreciated that conventional CPUs that employ point-to-point data links are typically only configured to be able to communicate with other CPUs that are directly coupled to the conventional CPU itself. Advantageously, the data agent may remove this conventional restriction and enable the CPUs 14a-d to communicate with more CPUs that the CPUs 14a-d have point-to-point data ports. For example, if the CPUs 14a-d each have eight point-to-point data links 18a-k, each of the CPUs 14a-d could conventionally only be connected to eight other CPUs 14a-d. The data agents 16a-d, however, are configured to increase the number of CPUs 14a-d that one of the CPUs, such as the CPU 14a for example, can communicate with by coupling the CPU 14a to a router or switch, such as a crossbar assembly 34, that is described further below in regard to FIG. 2.

In alternate embodiments, a different number of data agents 16 may be employed on the cell boards 12a and 12b. For example, a single data agent 16 may serve both of the CPUs 14 on each of the cell boards 12a and 12b, or each of the CPUs 14 may have two or more data agents 16. In still other embodiments, the functionality of the data agents 16 may be integrated into the CPUs 14a-d. In addition, it will be appreciated that while the CPUs 14a and 14b and the data agents 16a and 16b are illustrated as disposed on a single PCB (the cell board 12a, for example), these elements can be disposed on different PCBs. The same holds true for the elements disposed on the cell board 12b.

Turning next to FIG. 2, a block diagram of a symmetric multiprocessing (“SMP”) system 30 in accordance with one embodiment is illustrated. For simplicity, like reference numerals have been used to indicate those elements previously described in regard to FIG. 1. The SMP system 30 includes a first cabinet 32a and a second cabinet 32b. The first cabinet 32a and the second cabinet 32b may include multiple pairs 10 of even cell boards 12a and odd cell boards 12b. In the exemplary embodiment illustrated in FIG. 2, the first cabinet 32a and the second cabinet 32b include eight pairs of cell boards 10a-10h and 10i-10p, respectively, for a total of 64 CPUs 14 in the exemplary SMP system 30 (32 CPUs per cabinet 32a,b). In alternate embodiments, however, there may be a different number of cell board pairs 10 per cabinet 32 and/or a different number of cabinets. For example, in one alternate embodiment, the SMP system 30 may include three cabinets 32.

As illustrated in FIG. 2, each of the cell board pairs 10a-10h and 10i-10p may be coupled to one or more crossbar assemblies 34a, 34b, 34c, and 34d (hereafter “34a-d”). In particular, the data agents 16a,b on each of the even cell boards 12a within the first cabinet 32a may be coupled to the crossbar assembly 34a, and each of the data agents 16c,d within the odd cell boards 12b within the first cabinet 32a may be coupled to the crossbar assembly 34b. Similarly, the data agents 16a,b on the even cell boards 12a within the second cabinet 32b may be coupled to the crossbar assembly 34c, and the data agents 16c,d on the odd cell boards 12b within the second cabinet 32b may be coupled to the crossbar assembly 34d.

The data agents 16 within the first cabinet 32a and the second cabinet 32b may be coupled to the crossbars 34a-d via data links 36a, 36b, 36c, 36d (hereafter “36a-d ”) that are identical or similar to the data links 18a-k, described above in regard to FIG. 1. As such, in one embodiment, the data links 36a-d may include one or more SERDES differential pairs. In alternate embodiments, other types of data links or connections may be employed to couple the data agents 16 on the cell boards 10a-p to the crossbars 34a, 34b, 34c, or 34d.

As described above, the cell boards 10a-p may be coupled to the crossbar assemblies 34a-d, which are hereafter referred to more simply as the crossbars 34a-d. In various embodiments, the crossbars may comprise 8-port crossbars, 10-port crossbars, 12-port crossbars, 16-port crossbars, 20-port crossbars, and so forth. One exemplary crossbar is the crossbars that are employed with sx1000 chipset produced by Hewlett Packard. The crossbars 34a-d are switches configured to receive data from one of the data agents 16 within the cabinets 32a and 32b or from another crossbar 34a-d, and to transmit the received data to either another one of the crossbars 34a-d or to another data agent 16. For example, if a CPU 14a within the cell board pair 10a wants to communicate with a CPU 14b within the cell board pair 10h, the CPU 14a may transmit a signal to the data agent 16a, (or 16b) within the cell board pair 10a. The data agent 16a, within the cell board 10a would then communicate the signal to the crossbar 34a, which would transmit the signal to the data agent 16b (or 16a) within the cell board 10h. This transmission of the signal through the crossbar 34a may be referred as a “crossbar hop.” The data agent 16b within the cell board 10h would then transmit the signal to the CPU 14b on the cell board 10h. In other words, advantageously a signal can be transmitted from one CPU 14a-d to another CPU 14a-d within one of the cabinets 32a or 32b over no more than one crossbar hop, which greatly reduces the latency of the SMP system 30 over conventional SMP systems.

A similar process occurs if one the CPUs 14 within first cabinet 32a wants to communicate with one of the CPUs 14 within the second cabinet or vice-versa. The main difference is that whereas it is possible for one of the CPUs 14 to communicate with any other CPU 14 within the same cabinet with only a single crossbar hop or less (see above), transmitting signals between the cabinets 32a and 32 takes two crossbar hops. For example, again looking at the CPU 14a within the cell board pair 10a, if the CPU 14a wants to communicate a signal to the CPU 14c within the cell board pair 10n (which is in the other cabinet), the CPU 14a may begin by transmitting the signal to the data agent 16a, (or 16b) within the cell board pair 10a. The data agent 16a, may then transmit the signal to the crossbar 34a, which will determine that the signal is intended for a CPU 14c within the second cabinet 32b. The crossbar 34a will then transmit the signal to the crossbar 34d (i.e., the closest crossbar to the CPU 14c) via data links 38 (see below). The crossbar 34d may then transmit the signal to the data agent 16c (or 16d) within the cell board pair 10n, which will transmit the signal to the CPU 14c.

Another advantage of the exemplary SMP system 30 is the number of redundant data paths within the system 30. For example, as described above, a signal from the CPU 14a within the cell board pair 10a to the CPU 14c within the cell board pair 10n may travel via the crossbars 34a and 34d. Alternatively, however, the signal may also be transmitted from the CPU 14a across the data link 18a to the CPUs 14c or 14d and then to the cell board pair 10n via the crossbars 34b and 34d. In still another possibility, the signal could be transmitted from the crossbar 34a to the crossbar 34c and then be transmitted across the cell board 12a within the cell board pair 10n to the CPU 14c. It will be appreciated that the above-described signal routing possibilities merely are three of many possibilities.

As described above, the crossbars 34a-d may be utilized to transmit data between cell board pairs 10 within a single cabinet 32a, b or between two or more cabinets 32a, b. In order to be able to simultaneously transmit signals amongst various pairs of CPUs 14, the crossbars 34a-d may employ multiple connections (referred to as “crossbar switch planes”), each of which is able to relay a transmission between a pair of data agents 16. In one embodiment, each of the data agents 16a-d may have at least one switch plane to communicate with other like-positioned data agents on other cell boards. For example, a CPU 14a on the cell board pair 10a may be communicating with a CPU 14b on the cell board pair 10b on one crossbar switch plane, while the CPU 14a on the cell board pair 10c is communicating with the CPU 14a on the cell board pair 10j, and so forth. The crossbar 34a may have at least one switch plane for each of the data agents 16a, in the first cabinet 32a to use to communicate. In one embodiment, the crossbar 34a has eight switch planes per data agent 16.

In addition, in some embodiments, the data agents 16 may be able to employ multiple crossbar switch planes for a single transmission. For example, one of the data agents 16 may divide a transmission between any two CPUs 14 across multiple crossbar switch planes to boost the bandwidth available between the two CPUs 14. As such, multiple crossbar switch planes provide redundancy and bandwidth to the SMP system 30.

As described above, the crossbars 34a-d may be interconnected by the data links 38. As with the data links 18a-k and 36, the data links 38 may be wires, cables, or traces that are suitable for coupling the crossbars 34a-d together. In one embodiment, the data links 38 may include pairs of wires configured to transmit SERDES data. In another embodiment, the data links 38 may include fiber optic cable or another suitable high speed transmission medium.

In addition to interconnecting the cell board pairs 10 within the first cabinet 32a and the second cabinet 32b, the crossbars 34a-d may also provide connectivity between the cell board pairs 10a-10p and one or more input/output (“I/O”) devices 40. As illustrated in FIG. 2, the I/O devices 40 may be coupled to the crossbars 34 via data links similar to or the same as the data links 38 (e.g., SERDES data links). As such, the CPUs 14 and/or the data agents 16 may be configured to communicate with the I/O devices in a manner similar to the inter-CPU communication described above. In various embodiments, the I/O devices may include display devices, storage devices, human input devices, network interfaces, printing devices, and so forth. This exemplary list of I/O devices 40 is not intended to be exclusive. In one embodiment, the I/O devices 40 may include a system for interfacing the CPUs 14a-d with off-the-shelf I/O devices, such as Peripheral Components Interconnect (“PCI”) cards or Universal Serial Bus (“USB”) devices.

Turning next to FIG. 3, a graphical representation of a physical implementation of the SMP system 30, described in regard to FIG. 2, is illustrated. For simplicity, like reference numerals have been used for those elements previously described in regard to FIGS. 1 and 2. As with FIG. 2, FIG. 3 illustrates sixteen cell board pairs 10a-10p arrayed into the cabinets 32a and 32b. Each of the cell board pairs 10 includes one even cell board 12a and one odd cell board 12b, each of which include two CPUs 14 and two data agents 16. In addition, FIG. 3 also illustrates a power adapter 42a on each of the cell boards 12a, b. The power adapter 42a may be configured to convert power from a power source (not shown) to provide power to the cell boards 12a, b of the SMP system 30. Further, the cell boards 12a, b may also include one or more banks of memory 44a. As those of ordinary skill in the art will appreciate, the memory 44a may support the operation of the CPUs 14.

In the physical implementation illustrated in FIG. 3, the data links 18a between the even cell boards 12a and the odd cell boards 12b and the data links 36a-d between the data agents 16 and the crossbars 34a-d may be routed through a midplane 46a and a midplane 46b respectively, which are connected to each other. More specifically, signals from the CPUs 14a and 14b on the even cell boards 12a to the CPUs 14c and 14d on the corresponding odd cell board 12b may be routed through SERDES data links integrated into the midplanes 46a and 46b. Similarly, signals intended for the crossbars 34a-d may be routed through the midplanes 46a and 46b to the crossbars 34a-d, which may be directly coupled to the midplanes 46a and 46b, as illustrated in FIG. 3. The crossbars 34a-d may then be coupled together by SERDES compliant cabling (not shown).

One advantage of the physical implementation of the SMP system 30 illustrated in FIG. 3, is the cooling effects of the design. It will be appreciated that 64 CPUs 14, 64 data agents 16, 4 crossbars 34, and the other above-described components can generate a considerable amount of heat. The midplane-based design illustrated in FIG. 3 advantageously provides ventilation both between the cabinets 32a and 32b and between the even cell boards 12a and the odd cell boards 12b within each of the cell board pairs. In addition, the mid-plane design also enables multi-cabinet connections to be made via printed circuit boards (“PCB”) instead of cabling, which are typically more expensive than PCB connections.

As described above, the cell board pair 10 illustrated in FIG. 1 is only one possible embodiment of a cell board configuration suitable for use with the SMP system 30. Accordingly, FIG. 4 is a block diagram of another exemplary cell board pair 50 in accordance with another embodiment. For simplicity, like reference numerals have been used to designate those features previously described with regard to FIGS. 1-3. As illustrated, the cell board pair 50 includes two cell boards 52a and 52b. As with the cell boards 12a and 12b, the cell boards 52a and 52b each include two CPUs 14a-d and two data agents 16a-d.

Unlike the embodiment illustrated in FIG. 1, the CPUs 14a-d disposed on each of the cell boards 52a and 52b are connected directly with each other (via data links 18t and 1u, respectively), but directly connected to the CPUs 52c and 52d on the other cell board. Instead, each of the CPUs 14a-d have two point-to-point data links 18 1-s to each of the data agents 16a-d on their respective cell boards 52a and 52b. As such, if the CPU 14a wants to communicate with the CPU 14c or the other cell board, it would transmit a signal to the one of the data agents 16a, or 16b, which would transmit the signal to the crossbar 34. The crossbar 34 would then transmit the signal to one of the data agents 16cor 16d, which would transmit the signal to the CPU 14c. The configuration illustrated in FIG. 4 may be especially advantageous for CPUs 14a-d that have relatively few point-to-point data links, such as the Alpha EV7 processor, which has four point-to-point data links, and the AMD Opteron processor, which has three point to point links, because these processor do not have enough point-to-point data links to be interconnected in the manner illustrated in FIG. 1. Even though such CPUs do not have the same potential total bandwidth as the CPUs illustrated in FIG. 1, the cell board pair still provides interconnectivity within either the first cabinet 32a or the second cabinet 32 in one crossbar hop.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A computer system comprising:
a first cell board including:
a first central processing unit;
a second central processing unit; and
a first data agent coupled to the first and second central processing units and configured to transmit signals from the first and second central processing units to a first crossbar circuit; and
a second cell board including:
a third central processing unit coupled to the first central processing unit via a point-to-point data link;
a fourth central processing unit; and
a second data agent coupled to the third and fourth central processing units and configured to transmit signals from the third and fourth central processing units to a second crossbar circuit.

2. The computer system, as set forth in claim 1, wherein the first central processing unit is coupled to the fourth central processing unit via a point-to-point data link.

3. The computer system, as set forth in claim 2, wherein the first central processing unit is coupled to the second central processing unit via a point-to-point data link.

4. The computer system, as set forth in claim 2, wherein the first central processing unit is coupled to the third central processing unit via a serializer/deserializer (SERDES) data link.

5. The computer system, as set forth in claim 1, comprising:
a first cabinet, wherein the first and second cell boards are disposed within the first cabinet;
a second cabinet configured substantially similar to the first cabinet; and
the first crossbar circuit configured to transmit signals between the cell boards disposed in the first and second cabinets.

6. The computer system, as set forth in claim 5, wherein the first cabinet comprises sixteen cell boards.

7. The computer system, as set forth in claim 1, wherein the crossbar is configured to support sixteen crossbar planes.

8. (canceled)

9. The computer system, as set forth in claim 1, comprising a midplane configured to couple the first central processing unit and the third central processing unit together.

10. The computer system, as set forth in claim 9, wherein the midplane is configured to couple the first data agent and the first crossbar circuit together.

11. A method of manufacturing comprising:
providing a first cell board including:
a first central processing unit;
a second central processing unit; and
a first data agent coupled to the first and second central processing units and configured to transmit signals from the first and second central processing units to a first crossbar circuit; and
providing a second cell board including:
a third central processing unit coupled to the first central processing unit via a point-to-point data link;
a fourth central processing unit; and
a second data agent coupled to the third and fourth central processing units and configured to transmit signals from the third and fourth central processing units to a second crossbar circuit.

12. The method, as set forth in claim 11, wherein the first central processing unit is coupled to the fourth central processing unit via a point-to-point data link.

13. The method, as set forth in claim 11, wherein the first central processing unit is coupled to the second central processing unit via a point-to-point data link.

14. The method, as set forth in claim 12, wherein the first central processing unit is coupled to the third central processing unit via a serializer/deserializer (SERDES) data link.

15. The method, as set forth in claim 11, comprising:
providing a first cabinet, wherein the first and second cell boards are disposed within the first cabinet;
providing a second cabinet configured substantially similar to the first cabinet; and
providing the first crossbar circuit configured to transmit signals between the cell boards disposed in the first and second cabinets.

16. A symmetric multiprocessing system comprising:
a first cabinet including thirty-two processors disposed on eight cell board pairs;
a second cabinet including thirty-two processors disposed on eight cell board pairs; and
four crossbars configured to provide interconnectivity between the processors in the first and second cabinets, wherein the symmetric multiprocessing system is configured such that each of the processors within the first cabinet are able to communicate with each other in one or fewer crossbar hops and with each of the processors in the second cabinet in two or fewer crossbar hops.

17. The system, as set forth in claim 16, wherein each of the four crossbars are coupled to a respective eight of the cell boards in first cabinet or a respectively eight of the cell boards in the second cabinet.

18. The system, as set forth in claim 16, wherein at least one of the four crossbars is coupled to an input/output device, wherein one of the processors is configured to access the input/output device.

19. (canceled)

20. The system, as set forth in claim 16, wherein the processors on one of the eight cell board pairs are configured to communicate with each other via point-to-point data links.
